(19) United States
(12) Patent Application Publication
(10) Pub. No.: US 2019/0134784 A1
(43) Pub. Date: May 9, 2019

(54) UNIVERSAL HOLDER FOR WORKPIECE TO BE MACHINED

(71) Applicant: NewToolConcept Sarl, Bienne (CH)

(72) Inventor: Jacques Frund, Bienne (CH)

(21) Appl. No.: 16/096,371

(22) PCT Filed: Feb. 10, 2017
(86) PCT No.: PCT/IB2017/050745

§ 371 Date: Oct. 25, 2018

(30) Foreign Application Priority Data
Feb. 11, 2016 (CH) 00178/16

(51) Int. Cl. B25B 5/08; B25B 11/00; B23Q 3/06; B23Q 3/10; B25B 5/00

(52) U.S. Cl. CPC B25B 5/08; B25B 11/00; B25B 5/006; B23Q 3/103; B23Q 3/105; B23Q 3/06

(57) ABSTRACT

A universal holder for a workpiece to be machined including a serrated inclined plane and an equally serrated positioning block mounted in a movable manner along the inclined plane in an adjustment position and in a fixed manner along the inclined plane in a clamping position for a machining operation.

### TECHNICAL FIELD

The present invention relates to a universal holder for a workpiece to be machined.

The present invention particularly relates to a holder that can be adapted as a function of the workpiece to be machined.

### PRIOR ART

Various holders are known for workpieces to be machined that are adaptable as a function of the workpiece to be machined.

Document IN 1170KO/2013 discloses a workpiece holder intended to hold and guide cylindrical parts. A clamping assembly allows adaptation to various cylindrical parts according to their lengths.

This solution has the disadvantage of only being adapted to cylindrical parts.

Document WO 2006/096176 discloses a workpiece holder that is portable and vertically adjustable as a function of the workpiece to be machined. The tool has two jaws, one of which can move vertically in order to move away from or, on the contrary, approach the second jaw as a function of the size of the workpiece to be machined.

Document EP 2862669 discloses a workpiece holder for holding a workpiece to be machined comprising a base body and two jaws each having a clamping part. The clamping parts of the jaws, in a clamping direction, are spaced apart at a distance from each other and between each other by a forming space, in which a workpiece to be machined in abutment on the workpiece holder can be arranged. Furthermore, at least one of the clamping jaws is driven by a motor in the clamping direction in order to set the distance between the clamping parts so as to adjust them. In this way, a workpiece holder is provided, with a workpiece being able to be inserted in a variable manner, without requiring any of the parts of the workpiece holder to be exchanged, so as to adapt to various parts.

These solutions have the disadvantage of only providing a device for clamping the workpiece, without any real possibilities for adjusting or adapting the position of the workpiece as a function of the desired machining conditions.

Document EP 2365894 discloses a workpiece holder with a base and a plurality of workpiece holders distributed over the base, each being intended to receive a shaft of a workpiece to be machined, at least one part of the workpiece holders each comprising a sleeve intended to surround the shaft, which can be changed between a loading configuration, in which the shaft can be introduced into the sleeve or withdrawn from the sleeve, and a gripping configuration, in which the sleeve is compressed so that it blocks the shaft that it surrounds, and mechanical fixing means that can be switched between an active position, in which they act on the sleeve so as to keep it in its gripping configuration, and an inactive position, in which they do not act on the sleeve in this way, leaving the sleeve in its loading configuration. The sleeve is detachably disposed in a recess and is made up of an elastically deformable material, the mechanical fixing means coming into abutment against the outside of the sleeve in their active position.

The solution introduces a base providing a plurality of workpiece holders. The holders are provided in a fixed manner and do not allow the height of the workpiece to be adapted to facilitate the machining operation. The solution is complex to implement and does not guarantee firm, vibration-free fixing.

### BRIEF SUMMARY OF THE INVENTION

An aim of the present invention is to propose a universal holder for a workpiece to be machined that allows a single holder to be used for machining various types of workpieces.

Another aim of the invention involves providing a single and universal workpiece holder, avoiding having to design and manufacture a new adapter each time a new part is considered.

To this end, the invention provides a universal holder for a workpiece to be machined comprising a serrated inclined plane and an equally serrated positioning block mounted in a movable manner along the inclined plane in an adjustment position and mounted in a fixed manner along the inclined plane in a clamping position for a machining operation.

Therefore, the holder can be operated either in an adjustment position, with a movable positioning block, or in a clamping position, with a fixed positioning block.

This solution particularly has the advantage of being adaptable according to the workpiece to be machined, with the same holder being able to be used for machining a plurality of types of parts of different sizes and shapes.

Furthermore, the use of the same holder for a plurality of different workpieces enables a significant reduction in costs.

Advantageously, the adjustment of the block along the serrated inclined plane is carried out by a bolt allowing said positioning block to be placed in a selected position along said inclined plane, the transition from the adjustment position to the clamping position for a machining operation being implemented by clamping a clamping cam provided in a hollow shaft substantially parallel to the inclined plane, the positioning block and the clamping cam being connected together through a longitudinal slot arranged along the serrated inclined plane.

This solution has the advantage of providing the workpiece with retention security during the machining operation that is particularly vibration resistant.

According to an advantageous embodiment, the clamping cam comprises a pair of movable clamping planes, controlled by a clamping screw and cooperating with two fixed inclined planes, so that the clamping of the screw leads to a radial offset of the clamping planes, allowing the movable bolt to be clamped in the hollow shaft, in order to obtain the clamping position for a machining operation.

According to an advantageous embodiment, in the adjustment position, the corresponding serrated portions of the inclined plane and of the positioning block are sufficiently spaced apart to allow the block to slide along said inclined plane.

According to another advantageous embodiment, in the clamping position for a machining operation, the corresponding serrated portions of the inclined plane and of the positioning block are in contact, thus creating a plurality of support points for the block against the inclined plane. This embodiment provides a solid and rigid support for a vibration-free machining operation, in addition to effective clamping avoiding any undesired movement of the workpiece to be machined.

Advantageously, the positioning block comprises an installation plane, against which an adapter can be positioned, and at least one fastening stud for rigidly fixing said adapter.

This solution allows a very simple adapter-clamp or holder to be provided for fastening the workpiece to the holder in a plurality of arrangements and configurations.

Advantageously, the holder also comprises a rotary base rotationally mounted in a fixed base, allowing the universal holder and the positioning block to angularly move about an axis substantially perpendicular to the fixed base. This simple and reliable arrangement allows the workpiece to be machined to be positioned in the ideal angular position for correct machining.

At least one clamping screw advantageously allows the angular position of the rotary base to be fixed in the fixed base.

### BRIEF DESCRIPTION OF THE FIGURES

Embodiments of the invention are provided in the description that is illustrated by the accompanying figures, in which:

FIG. 1 shows a perspective view of an example of a workpiece holder according to the invention;

FIG. 2 shows a section view of the workpiece holder of FIG. 1;

FIG. 3 shows a perspective view of an example of a positioning block and a movable bolt according to the invention;

FIG. 4 shows a section view of the movable bolt and of the positioning block of FIG. 3.

### DETAILED DESCRIPTION OF THE INVENTION

FIG. 1 shows an embodiment of a universal holder 1 for a workpiece to be machined. It comprises two main parts, namely, first and foremost, a substantially rectangular body 9 oriented substantially vertically, one of the sides of which is provided with a serrated inclined plane 2. An equally serrated positioning block 3 is mounted in a movable manner along the inclined plane 2. The positioning block 3 comprises an installation plane 12, against which an adapter or a clamp can be positioned, using at least one fastening stud 13, for example, or using other screwing or clamping fixing means. It is then easy to fasten any type of workpiece, regardless of its shape, with a minimum amount of adaptation work.

The multiple corresponding serrated portions of the inclined plane 2 and of the positioning block 3 create a plurality of support points for the block against the inclined plane. The user thus can easily select a suitable position as a function of the workpiece that must be held by the holder.

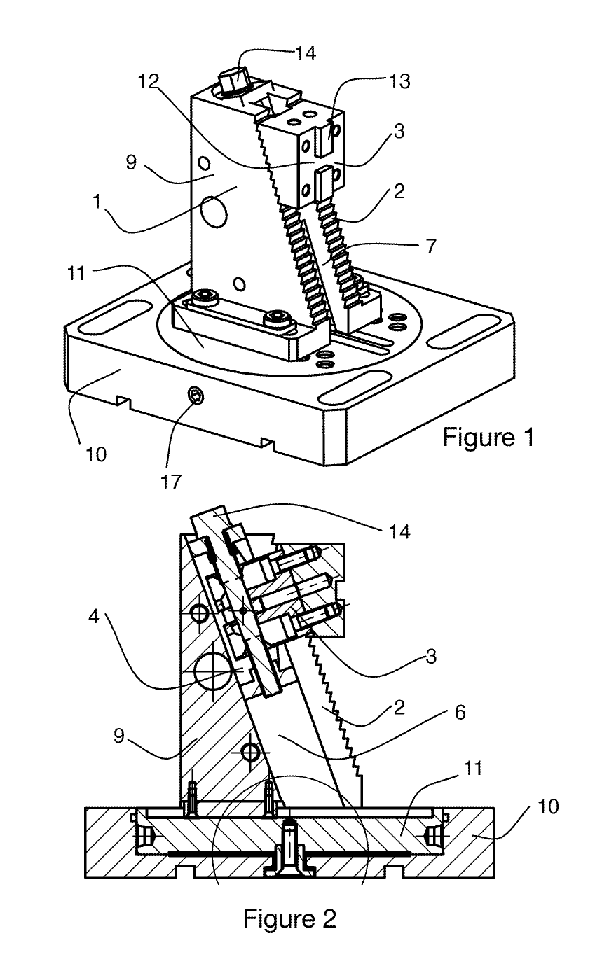

As can be seen in FIG. 2, the block 3 is adjusted along the serrated inclined plane 2 by a bolt 4 that allows said positioning block 3 to be placed in a selected position along the inclined plane 2. The body 9 also provides a hollow shaft 6 substantially parallel to the inclined plane 2. This hollow shaft allows a cam 5 to be accommodated for clamping the bolt 4. A longitudinal slot 7 arranged along the serrated inclined plane 2 allows the positioning block 3 and the clamping cam 5 to be connected.

By virtue of the bolt 4, the positioning block 3 can be configured in an adjustment position, in which the block is movable along the inclined plane, or a clamping position, in which the block 3 is firmly held in place.

In the adjustment position, the corresponding serrated portions of the inclined plane 2 and of the positioning block 3 are sufficiently spaced apart to allow the block 3 to slide along said inclined plane.

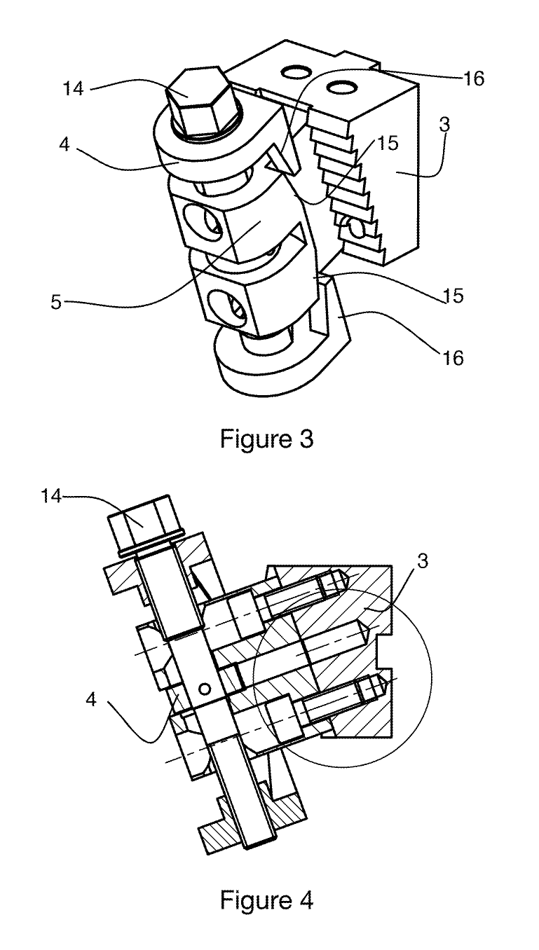

As shown in FIG. 3, in the clamping position for a machining operation, the corresponding serrated portions of the inclined plane 2 and of the positioning block 3 are in contact, thus creating a plurality of support points for the block against the inclined plane. The support that is obtained is firm, stable and provides vibration-free retention, even under machining conditions involving significant forces.

As shown in FIGS. 2, 3 and 4, a clamping screw 14 allows one or the other of the positions to be implemented. To this end, the clamping cam 5 comprises a pair of movable clamping planes 16, controlled by the clamping screw 14 and cooperating with two fixed inclined planes 15, so that the clamping of the screw 14 results in a radial offset of the clamping planes 16, allowing the bolt 4 to be clamped.

As can be seen in FIGS. 1 and 2, in order to be able to place the body 9 and the inclined plane 2 in a plurality of angular configurations, the universal holder provides a rotary base 11 rotationally mounted in a fixed base 10. This arrangement allows angular movement of the universal holder and the positioning block 3 about an axis substantially perpendicular to the fixed base 10. In order to be secured in the desired angular position, at least one clamping screw 17 (or any other angular locking means) allows the angular position of the rotary base 11 to be fixed in the fixed base 10.

### REFERENCE NUMERALS USED IN THE FIGURES

1 Universal holder
2 Serrated inclined plane
3 Positioning block
4 Movable bolt
5 Clamping cam
6 Hollow shaft
7 Longitudinal slot
9 Universal holder body
10 Fixed base
11 Rotary base
12 Installation plane
13 Fastening stud
14 Clamping screw
15 Clamping plane
16 Clearance plane
17 Clamping screw

What is claimed is:

1. A universal holder (1) for a workpiece to be machined comprising a serrated inclined plane (2) and an equally serrated positioning block (3) mounted in a movable manner along the inclined plane (2) in an adjustment position and mounted in a fixed manner along the inclined plane (2) in a clamping position for a machining operation.

2. The universal holder (1) for a workpiece to be machined as claimed in claim 1, wherein the adjustment of the block along the serrated inclined plane (2) is carried out by a bolt (4) allowing said positioning block (3) to be placed in a selected position along said inclined plane (2), the transition from the adjustment position to the clamping position for a machining operation being implemented by clamping a clamping cam (5) provided in a hollow shaft (6) substantially parallel to the inclined plane (2), the positioning block (3) and the clamping cam (5) being connected together through a longitudinal slot (7) arranged along the serrated inclined plane (2).

3. The universal holder (1) for a workpiece to be machined as claimed in claim 1, wherein the clamping cam (5) comprises a pair of movable clamping planes (16), controlled by a clamping screw (14) and cooperating with two fixed inclined planes (15), so that the clamping of the screw (14) leads to a radial offset of the clamping planes (16), allowing the movable bolt (4) to be clamped in the hollow shaft (6), in order to obtain the clamping position for a machining operation.

4. The universal holder (1) for a workpiece to be machined as claimed in claim 1, wherein, in the adjustment position, the corresponding serrated portions of the inclined plane (2) and of the positioning block (3) are sufficiently spaced apart to allow the block (3) to slide along said inclined plane.

5. The universal holder (1) for a workpiece to be machined as claimed in claim 1, wherein, in the clamping position for a machining operation, the corresponding serrated portions of the inclined plane (2) and of the positioning block (3) are in contact, thus creating a plurality of support points for the block against the inclined plane.

6. The universal holder (1) for a workpiece to be machined as claimed in claim 1, wherein the positioning block (3) comprises an installation plane (12), against which an adapter can be positioned, and at least one fastening stud (13) for rigidly fixing said adapter.

7. The universal holder (1) for a workpiece to be machined as claimed in claim 1, further comprising a rotary base (11) rotationally mounted in a fixed base (10), allowing the universal holder and the positioning block (3) to angularly move about an axis substantially perpendicular to the fixed base (10).

8. The universal holder (1) for a workpiece to be machined as claimed in claim 7, wherein at least one clamping screw (17) allows the angular position of the rotary base (11) to be fixed in the fixed base (10).
